(19) United States
(12) Patent Application Publication
(10) Pub. No.: US 2024/0217839 A1
(43) Pub. Date: Jul. 4, 2024

(54) POSITIVE ELECTRODE MATERIAL FOR LITHIUM BATTERY, PREPARATION METHOD THEREOF AND LITHIUM BATTERY

(71) Applicant: NAN YA PLASTICS CORPORATION, TAIPEI (TW)

(72) Inventors: Te-Chao Liao, Taipei (TW); Wei-Sheng Cheng, Taipei (TW); Chia-Shan Chang, Taipei (TW)

(73) Assignee: NAN YA PLASTICS CORPORATION, TAIPEI (TW)

(21) Appl. No.: 18/178,532

(22) Filed: Mar. 6, 2023

(30) Foreign Application Priority Data
Dec. 30, 2022 (TW) 111150792

(51) Int. Cl. C01G 53/00; H01M 10/052

(52) U.S. Cl. CPC C01G 53/006; C01G 53/44; H01M 10/052; C01P 2004/61; C01P 2006/40; C01P 2006/80

(57) ABSTRACT

A positive electrode material for a lithium battery, a lithium battery comprising the same, and a method for preparing the positive electrode material are provided. The positive electrode material for a lithium battery comprises tungsten-doped lithium nickel manganese oxide modified by a nitrogen-doped carbonaceous material.

### CROSS-REFERENCE TO RELATED APPLICATION

This application claims the priority benefit of Taiwan application serial no. 111150792, filed on Dec. 30, 2022. The entirety of the above-mentioned patent application is hereby incorporated by reference herein and made a part of this specification.

### BACKGROUND

### Technical Field

The disclosure relates to a positive electrode material for a lithium battery, a lithium battery comprising the same, and a method for preparing the positive electrode material.

### Description of Related Art

A lithium nickel manganese oxide material has a three-dimensional large tunnel structure and good conductivity, which is very suitable for lithium ion diffusion, so it has been tried to be used as a positive electrode material for a lithium battery. However, the lithium nickel manganese oxide material currently on the market is not satisfied since it has a relatively low specific capacity. Therefore, developing a positive electrode material with improved specific capacity has still been the focus of research in this technical field.

### SUMMARY

The disclosure provides a positive electrode material for a lithium battery with improved specific capacity by doping tungsten in a lithium nickel manganese oxide material and modifying the surface of the tungsten-doped lithium nickel manganese oxide material with a nitrogen- doped carbonaceous material.

The disclosure provides a positive electrode material for a lithium battery comprising tungsten-doped lithium nickel manganese oxide modified by a nitrogen-doped carbonaceous material.

In an embodiment of the disclosure, a weight ratio of the nitrogen-doped carbonaceous material to the lithium nickel manganese oxide is 1:9 to 1:2 in the tungsten-doped lithium nickel manganese oxide modified by the nitrogen-doped carbonaceous material.

In an embodiment of the disclosure, an average particle size of the tungsten-doped lithium nickel manganese oxide modified by the nitrogen-doped carbonaceous material is 1 μm to 100 μm.

In an embodiment of the disclosure, a ratio of a sum of molar numbers of nickel and manganese to a molar number of lithium is 1:1 to 1:4 in the tungsten-doped lithium nickel manganese oxide modified by the nitrogen-doped carbonaceous material.

In an embodiment of the disclosure, a ratio of a sum of molar numbers of nickel and manganese to a molar number of tungsten is 1:0.5 in the tungsten-doped lithium nickel manganese oxide modified by the nitrogen-doped carbonaceous material.

The disclosure provides a method for preparing a positive electrode material for a lithium battery, comprising:
1) preparing a nickel manganese oxide precursor from nickel source and manganese source by a coprecipitation method;
2) preparing a tungsten lithium nickel manganese oxide precursor from tungsten source, lithium source and the nickel manganese oxide precursor by the coprecipitation method;
3) preparing tungsten doped lithium nickel manganese oxide by sintering the tungsten lithium nickel manganese oxide precursor at high temperature; and
4) modifying the tungsten doped lithium nickel manganese oxide with a nitrogen-doped carbonaceous material.

In an embodiment of the disclosure, the modifying the tungsten doped lithium nickel manganese oxide with a nitrogen-doped carbonaceous material comprises:
1) dispersing nitrogen-containing compound and the tungsten doped lithium nickel manganese oxide in a solvent to prepare a reaction solution;
2) preparing an intermediate product by subjecting the reaction solution to a temperature of to 80° C. and a pressure of 1000 to 1500 psi under an atmosphere of carbon dioxide; and
3) calcining the intermediate product at 400˜800° ° C. under an inert gas atmosphere.

In an embodiment of the disclosure, the nitrogen-containing compound comprising one or more of pyrrole, phenylpyrrole, pyridine, graphite carbon nitride, ethylenediamine, propylenediamine, benzenediamine, melamine and aniline.

In an embodiment of the disclosure, the tungsten source comprises ammonium metatungstate, tungsten hexachloride, sodium tungstate, ammonium tungstate, tungsten disulfide or a mixture thereof.

The disclosure provides a lithium battery including the positive electrode material for the lithium battery as mentioned above.

The positive electrode material for a lithium battery according to the disclosure has improved specific capacity and reduced capacity loss by adding tungsten to the lattice of lithium nickel manganese oxide and modifying the surface of tungsten-doped lithium nickel manganese oxide with nitrogen-doped carbonaceous material.

In order for the features and advantages of the disclosure to be more comprehensible, the following embodiments are cited and described in detail as follows.

### BRIEF DESCRIPTION OF THE DRAWINGS

FIG. 1 is a graph showing the battery life of Example 1 and Comparative Example 3 at 25° C.

FIG. 2 a graph showing the battery life of Example 1 and Comparative Example 3 at 55° C.

### DESCRIPTION OF THE EMBODIMENTS

Hereinafter, an embodiment of the disclosure will be described in detail. However, these embodiments are exemplary, and the disclosure is not limited thereto.

Herein, a range indicated by “one value to another value” is a general representation which avoids enumerating all values in the range in the specification. Therefore, the record of a specific value range, any number within this numerical range and any smaller numerical range bounded by any number within that numerical range is contemplated as if such any number and such smaller numerical ranges were expressly written in the specification.

The specific capacity of the lithium battery according to the disclosure is improved by using the tungsten-doped lithium nickel manganese oxide modified by the nitrogen-doped carbonaceous material as the positive electrode material of the lithium battery.

The method for preparing the tungsten-doped lithium nickel manganese oxide modified by nitrogen-doped carbonaceous material of the disclosure may include:
1) preparing a nickel manganese oxide precursor from nickel source and manganese source by a coprecipitation method;
2) preparing a tungsten lithium nickel manganese oxide precursor from tungsten source, lithium source and the nickel manganese oxide precursor by the coprecipitation method;
3) preparing tungsten doped lithium nickel manganese oxide by sintering the tungsten lithium nickel manganese oxide precursor at high temperature; and
4) modifying the tungsten doped lithium nickel manganese oxide with a nitrogen-doped carbonaceous material.

Each step of the method for preparing the tungsten-doped lithium nickel manganese oxide modified by nitrogen-doped carbonaceous material of the disclosure is described below.

### Preparation of Nickel Manganese Oxide Precursor

In an embodiment of the disclosure, the nickel manganese oxide precursor may be prepared by a coprecipitation method. For example, a slurry of the nickel manganese oxide precursor may be obtained by subjecting a mixed aqueous solution of a nickel source and a manganese source (the atomic ratio of nickel to manganese is substantially 1:3) with a coprecipitating agent to a temperature of 300 to 500° C. for 9 to 12 hours to coprecipitate nickel and manganese. Preferably, the chemical formula of the nickel manganese oxide precursor may be Ni_{0.5}Mn_{1.5}O₄.

In an embodiment of the disclosure, the coprecipitating agent may be polyacrylamide or polyethylene glycol, but not limited thereto.

In an embodiment of the disclosure, the nickel source may be nickel chloride, nickel nitrate, nickel acetate, nickel sulfate or a mixture thereof, but is not limited thereto.

In an embodiment of the disclosure, the manganese source may be manganese chloride, manganese nitrate, manganese acetate, manganese sulfate or a mixture thereof, but is not limited thereto.

### Preparation of Tungsten Lithium Nickel Manganese Oxide Precursor

In an embodiment of the disclosure, the tungsten lithium nickel manganese oxide precursor may be prepared by a coprecipitation method. For example, the tungsten lithium nickel manganese oxide precursor may be prepared by adding lithium source and tungsten source into the slurry of the nickel manganese oxide precursor and then adding coprecipitating agent dropwisely into the mixture to perform a reaction at a temperature of 700 to 1000° C. for 4 to 10 hours to coprecipitate the tungsten lithium nickel manganese oxide precursor.

In an embodiment of the disclosure, the lithium source may comprise lithium hydroxide, lithium chloride, lithium nitrate, lithium acetate, lithium phosphate, dilithium hydrogen phosphate, lithium oxalate or a mixture thereof. Preferably, a ratio of a sum of molar numbers of nickel and manganese to a molar number of lithium is 1:1 to 1:4.

In an embodiment of the disclosure, the tungsten source may comprise ammonium metatungstate, tungsten hexachloride, sodium tungstate, ammonium tungstate, tungsten disulfide or a mixture thereof. Preferably, a ratio of the sum of molar numbers of nickel and manganese to a molar number of tungsten 1:0.5.

### Preparation of Tungsten-Doped Lithium Nickel Manganese Oxide

In an embodiment of the disclosure, after the solvent in the tungsten lithium nickel manganese oxide precursor is removed, high-temperature sintering is performed at a temperature of 400° ° C. to 1000° ° C. to complete lattice rearrangement to obtain the tungsten doped lithium nickel manganese oxide.

### Preparation of Tungsten-Doped Lithium Nickel Manganese Oxide Modified by the Nitrogen-Doped Carbonaceous Material

A nitrogen-containing compound as a precursor of a nitrogen-doped carbonaceous material and the tungsten doped lithium nickel manganese oxide are dispersed in a solvent at a weight ratio of about 10:90 to prepare a reaction solution. The reaction solution was vigorously stirred for one hour at a temperature of about 40-80° C. and a pressure of about 1000-1500 psi under an atmosphere of carbon dioxide, dried at 40-80° C., and finally calcined in a tubular high-temperature furnace at 400-800° C. for 3-10 hours under an inert gas atmosphere to obtain a tungsten-doped lithium nickel manganese oxide modified by the nitrogen-doped carbonaceous material to be used as a positive electrode material. The obtained tungsten-doped lithium nickel manganese oxide modified by the nitrogen-doped carbonaceous material may have an average particle size of about 1 μm to about 200 μm, for example, about 1 μm or more, about 4 μm or more, about 8 μm or more, about 20 μm or less, about 100 μm or less, or about 200 μm or less.

In an embodiment of the disclosure, the nitrogen-containing compound may be, for example, pyrrole-based compounds such as pyrrole or phenylpyrrole, pyridine-based compounds, graphite carbon nitride, diamine-based compounds such as ethylenediamine, propylenediamine, benzene diamine or the like, melamine or aniline, but not limited thereto.

In an embodiment of the disclosure, the solvent may be, for example, absolute ethanol, but is not limited thereto.

Since the size of nitrogen atom is close to that of carbon atom, the compatibility between them is high, and nitrogen may be easily doped in the lattice of carbonaceous materials. In the N—C bond formed after doping, the nitrogen atom will attract the electrons on the adjacent carbon atoms and induce them to generate electron defects, thereby promoting the conduction of electrons in the material and enhancing the conductive properties of the material.

In the process of preparing the tungsten-doped lithium nickel manganese oxide modified by the nitrogen-doped carbonaceous material according to the disclosure, tungsten and lithium are mixed-sintered, so the specific capacity is further improved and the capacity loss is further reduced. In addition, the nitrogen-doped carbonaceous material may increase the active sites on the surface of the material to reduce the energy barrier encountered when ions penetrate. Therefore, the transfer of lithium ions is facilitated.

The tungsten-doped lithium nickel manganese oxide modified by the nitrogen-doped carbonaceous material of the disclosure will be described in detail by using experimental examples. However, the following experimental examples are not intended to limit the disclosure.

### EXPERIMENTAL EXAMPLE

### Preparation of Positive Electrode Material

### Preparation Example 1: Preparation of Lithium Nickel Manganese Oxide

The precursor of Ni_{0.5}Mn_{1.5}O₄ was prepared by mixing polyacrylamide or polyethylene glycol as coprecipitating agent with nickel source and manganese source. Then, lithium hydroxide as lithium source, a dopant and an organic medium were added to the precursor and mechanically mixed to prepare a stable slurry. The ratio of a sum of molar numbers of nickel and manganese to a molar number of lithium was 1:1 to 1:4 in the slurry. Then, the precipitate in the slurry was sintered at a high temperature of 900 to 1200° C. to obtain lithium nickel manganese oxide as a positive electrode material 1. The positive electrode material 1 may have a D50 average particle size of about 12 μm.

### Preparation Example 2: Preparation of Lithium Nickel Manganese Oxide Modified by Nitrogen-Doped Carbonaceous Material

A nitrogen-containing compound as a precursor of a nitrogen-doped carbonaceous material and lithium nickel manganese oxide were dispersed in absolute ethanol at a weight ratio of about 10:90 to prepare a reaction solution. The reaction solution was vigorously stirred for one hour at a temperature of about 40-80° C. and a pressure of about 1200 psi under an atmosphere of carbon dioxide. The product was collected and dried at 40-80° C. for 12 hours in an oven and finally calcined in a tubular high-temperature furnace at 400-800° C. for 3-10 hours under an inert gas atmosphere to obtain lithium nickel manganese oxide modified by the nitrogen-doped carbonaceous material as a positive electrode material 2. The positive electrode material 2 may have a D50 average particle size of about 16 μm.

### Preparation Example 3: Preparation of Tungsten-Doped Lithium Nickel Manganese Oxide

The precursor of Ni_{0.5}Mn_{1.5}O₄ was prepared by mixing polyacrylamide or polyethylene glycol as coprecipitating agent with nickel source and manganese source. Then, lithium hydroxide, tungsten disulfide, a dopant and an organic medium were added to the precursor and mechanically mixed to prepare a stable slurry. The ratio of a sum of molar numbers of nickel and manganese: a molar number of lithium: a molar number of tungsten was 1: (1 to 4):0.5 in the slurry. Then, the precipitate in the slurry is sintered at a high temperature of 900 to 1200° C. to obtain tungsten doped lithium nickel manganese oxide as a positive electrode material 3. The positive electrode material 3 may have a D50 average particle size of about 14 μm.

### Preparation Example 4: Preparation of Tungsten-Doped Lithium Nickel Manganese Oxide Modified by Nitrogen-Doped Carbonaceous Material

A nitrogen-containing precursor (for example, phenylpyrrole nitrogen, pyridinium nitrogen, graphitic carbon nitride, diamine, melamine, or aniline) as a precursor of a nitrogen-doped carbonaceous material and tungsten-doped lithium nickel manganese oxide were dispersed in absolute ethanol at a weight ratio of about 10:90 to prepare a reaction solution. The reaction solution was vigorously stirred for one hour at a temperature of about 40-80° C. and a pressure of about 1200 psi under an atmosphere of carbon dioxide. The product was collected and dried at 40-80° C. for 12 hours in an oven and finally calcined in a tubular high-temperature furnace at 400-800° C. for 3-10 hours under an inert gas atmosphere to obtain tungsten-doped lithium nickel manganese oxide modified by the nitrogen-doped carbonaceous material as a positive electrode material 4. The positive electrode material 4 may have a D50 average particle size of about 15 μm.

### Preparation of lithium battery

### Example 1

80 parts by weight of the positive electrode material 4, 10 parts by weight of conductive carbon black and 10 parts by weight of binder were mixed in a solvent to form a uniform positive electrode slurry. Then, the positive electrode slurry was coated on an aluminum foil with a blade, and then moved to an oven to dry at 40-120° C., followed by calendered to obtain a positive electrode.

After a lower cover of a negative electrode was placed on an insulating platform, a metal lithium sheet was placed in the center of the lower cover of the negative electrode and pressed flat with a tablet pressing tool. A commercially available separator (Celgard 2400) on which an appropriate amount of liquid electrolyte was dropped was placed on the lithium sheet, and then the positive electrode prepared as mentioned above, a spacer, a spring, and a positive electrode cover were placed on the separator sequentially to provide a button-type lithium battery stack. Next, the button-type lithium battery stack was pressed with a pressure of 800 Pa in a battery pressing machine to provide a button-type lithium battery.

### Comparative Examples 1-3

A button-type lithium battery was prepared in the same manner as Example 1, but positive electrode material 4 was replaced by positive electrode material 1-3 prepared above.

### Evaluation

### Initial Discharge Capacity and Capacity Loss

A charge-discharge test was performed on the button-type lithium battery of Example 1 and Comparative Example 1-3 for 200 circles at 0.5C to observe the initial discharge capacity and capacity loss thereof. The discharge specific capacity at 25° C. of Example 1 and Comparative Examples 1-3 are shown in Table 1. The equation for calculating the capacity of different positive electrode materials for charging/discharging is as follows:

$$Specific capacity ( mAh / g ) = ( current ( mA ) \times time ( h ) ) / ( mass of active material ( g ) )$$

TABLE 1

| | | Comparative | Comparative | Comparative |
|---|---|---|---|---|
| | Example 1 | Example 1 | Example 2 | Example 3 |
| Positive electrode | tungsten-doped | lithium nickel | lithium nickel | tungsten-doped |
| material | lithium nickel | manganese oxide | manganese oxide | lithium nickel |
| | manganese oxide | | modified by the | manganese oxide |
| | modified by the | | nitrogen-doped | |
| | nitrogen-doped | | carbonaceous material | |
| | carbonaceous material | | | |
| Discharge specific | 133.3 | 116 | 122 | 130.4 |
| capacity (mAh/g) | | | | |

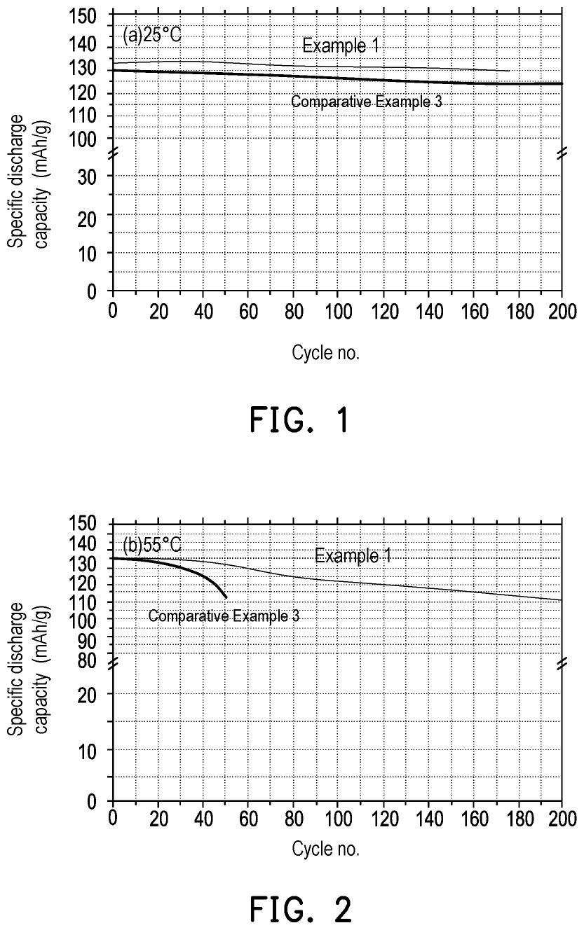

A standard lithium nickel manganese oxide full battery is requested to have charging/discharging capacity of 130 mAh/g under low current (0.1 C) (the theoretical capacity of lithium nickel manganese oxide is about 130 mAh/g). It may be observed from Table 1 that the positive electrode material of the disclosure may effectively increase the specific capacity of the lithium battery of Example 1 to above 130 mAh/g by doped with tungsten and modified with the nitrogen-doped carbonaceous material. FIG. 1 is a graph showing the battery life of Example 1 and Comparative Example 3 at 25° C., and FIG. 2 a graph showing the battery life of Example 1 and Comparative Example 3 at 55° C. It may be seen from FIG. 2 that the lithium battery of Example 1 may maintain a relatively high capacity even after 200 cycles of charging/discharging at 55° C., and the capacity loss per cycle is only about 0.1371, while the capacity of the lithium battery of Comparative Example 3 declines significantly after about 50 cycles of charging/discharging at 55° C., and the capacity loss per cycle is about 0.3928. It is confirmed that the positive electrode material of the disclosure may effectively reduce the capacity loss and prolong the battery life.

In summary, according to the disclosure, tungsten source and lithium source are added to the nickel manganese oxide precursor by coprecipitation method and sintering method which may reduce the particle size of the powder and improve the uniformity of doping. In addition, the positive electrode material of the disclosure improves the specific capacity of the lithium battery by modifying the surface of the tungsten-doped lithium nickel manganese oxide with nitrogen-doped carbonaceous material.

Although the disclosure has been disclosed in the above embodiments, the embodiments are not intended to limit the disclosure. Persons skilled in the art may make some changes and modifications without departing from the spirit and scope of the disclosure. The protection scope of the disclosure shall be defined by the appended claims.

What is claimed is:

1. A positive electrode material for a lithium battery, comprising tungsten-doped lithium nickel manganese oxide modified by a nitrogen-doped carbonaceous material.

2. The positive electrode material for a lithium battery of claim 1, wherein a weight ratio of the nitrogen-doped carbonaceous material to the lithium nickel manganese oxide is 1:9 to 1:2 in the tungsten-doped lithium nickel manganese oxide modified by the nitrogen-doped carbonaceous material.

3. The positive electrode material for a lithium battery of claim 1, wherein an average particle size of the tungsten-doped lithium nickel manganese oxide modified by the nitrogen-doped carbonaceous material is 1 μm to 100 μm.

4. The positive electrode material for a lithium battery of claim 1, wherein a ratio of a sum of molar numbers of nickel and manganese to a molar number of lithium is 1:1 to 1:4 in the tungsten-doped lithium nickel manganese oxide modified by the nitrogen-doped carbonaceous material.

5. The positive electrode material for a lithium battery of claim 1, wherein a ratio of a sum of molar numbers of nickel and manganese to a molar number of tungsten is 1:0.5 in the tungsten-doped lithium nickel manganese oxide modified by the nitrogen-doped carbonaceous material.

6. A method for preparing a positive electrode material for a lithium battery, comprising:
a) preparing a nickel manganese oxide precursor from nickel source and manganese source by a coprecipitation method;
b) preparing a tungsten lithium nickel manganese oxide precursor from tungsten source, lithium source and the nickel manganese oxide precursor by the coprecipitation method;
c) preparing tungsten doped lithium nickel manganese oxide by sintering the tungsten lithium nickel manganese oxide precursor at high temperature; and
d) modifying the tungsten doped lithium nickel manganese oxide with a nitrogen-doped carbonaceous material.

7. The method for preparing a positive electrode material for a lithium battery of claim 6, wherein the modifying the tungsten doped lithium nickel manganese oxide with the nitrogen-doped carbonaceous material comprising:
1) dispersing nitrogen-containing compound and the tungsten doped lithium nickel manganese oxide in a solvent to prepare a reaction solution;
2) preparing an intermediate product by subjecting the reaction solution to a temperature of 40 to 80° C. and a pressure of 1000 to 1500 psi under an atmosphere of carbon dioxide; and
3) calcining the intermediate product at 400˜800° ° C. under an inert gas atmosphere.

8. The method for preparing a positive electrode material for a lithium battery of claim 7, wherein the nitrogen-containing compound comprising one or more of pyrrole, phenylpyrrole, pyridine, graphite carbon nitride, ethylenediamine, propylenediamine, benzenediamine, melamine and aniline.

9. The method for preparing a positive electrode material for a lithium battery of claim 6, wherein the tungsten source comprises ammonium metatungstate, tungsten hexachloride, sodium tungstate, ammonium tungstate, tungsten disulfide or a mixture thereof.

10. A lithium battery comprising the positive electrode material for a lithium battery of claim 1.
